(19) United States
(12) Patent Application Publication
(10) Pub. No.: US 2023/0098326 A1
(43) Pub. Date: Mar. 30, 2023

(54) FEED SYSTEM FOR BAND-TYPE MATERIAL, AND COATING DEVICE AND METHOD

(71) Applicant: HOMAG GmbH, Schopfloch (DE)

(72) Inventors: Ludwig ALBRECHT, Dornstetten-Aach (DE); Patrick MÜLLER, Glatten (DE)

(21) Appl. No.: 17/802,935

(22) PCT Filed: Feb. 24, 2021
(86) PCT No.: PCT/EP2021/054524

§ 371 Date: Aug. 26, 2022

(30) Foreign Application Priority Data
Feb. 28, 2020 (DE) 10 2020 105 320.7

(51) Int. Cl. B27D 5/00

(52) U.S. Cl. CPC B27D 5/003

(57) ABSTRACT

The invention relates to a feed system for a band-type or strip-type material, in particular a coating material for coating a narrow side, or an adhesive strip, and also relates to a coating device. A method is also provided.

### TECHNICAL FIELD

The invention relates to a feed system for a band-type or strip-type material, in particular a coating material for coating a narrow side, or an adhesive strip, and a coating device. A method for feeding band-type or strip-type material, and a band-type or strip-type material, is also provided.

### PRIOR ART

In the prior art, it is known to provide a coating material for application to a narrow side of a workpiece (also referred to as an “edge tape”) in roll form. In order to ensure an efficient coating process, for example scales having a plurality of rollers received therein are provided for a coating device, which rollers are thus provided in the region of the coating device. In order to allow for a compact machine system having efficient storage, various approaches are known in this field.

DE 10 2011 006 319 A1 for example describes a machine system which comprises a coating unit and a feed means for feeding an edge tape material to a magazine unit of the coating unit. Furthermore, a store is provided, in which a plurality of edge materials can be stored, and a transport means for conveying edge tape material from the store to the feed means.

Although the system described in DE 10 2011 006 319 A1 has proven itself, it is found that, in the case of consumption of a roller with coating material an individual replacement of a roller of this kind must take place in order to ensure the operation of the machine. Even though this can take place during processing, a roller exchange requires certain logistics and time planning in order to prevent machine downtime in the absence of available coating material.

### SUMMARY OF THE INVENTION

An object of the invention is to provide a feed system for a band-type or strip-type material, a coating device, a method, and a band-type or strip-type material, which ensure continuous operation when coating workpieces.

A feed system of this kind is specified in claim 1, and a coating device of this kind is specified in claim 12. Furthermore, a method and a band-type or strip-type material is provided. Dependent claims relate to particular embodiments.

The feed system according to the invention is suitable for band-type or strip-type material, in particular coating material, such as an edge tape, or an adhesive strip. The feed system comprises a storage means for receiving a plurality of material units, and a transport means for moving a band-type or strip-type material from the storage means. The material units can each receive a coating material or an adhesive strip in roll form. The transport means further comprises a joining means for connecting end portions of band-type or strip-type materials. As a result, an endless material strip can be provided by means of the feed system.

An “end portion” means a portion at a start or an end of a band-type or strip-type material, in particular a coating material or an adhesive strip.

In one embodiment, the joining means is designed to adhesively bond, to tack, to crimp, to weld end portions of coating materials, and/or to connect these by means of a positive fit.

A positive fit can be implemented for example by a wedge-shaped or dovetail-like design or by a hook-like structure on the band-type or strip-type material. Thus, end portions of two band-type or strip-type materials can engage in one another, for example in the manner of mutually engaging puzzle pieces. A punching may also be provided on an end portion of the band-type or strip-type material, in which punching a complementary portion or a projection of an end portion of another band-type or strip-type material engages. Such an end portion of the band-type or strip-type material may be provided by the manufacturer, or otherwise made prior to or during use of the band-type or strip-type material.

The joining means may comprise one or more pressure rollers, in order to crimp end portions of the materials together. In order to adhesively bond the end portions, the joining means may comprise an adhesive application means and/or an adhesive activation means. For the purpose of welding, the joining means may comprise a welding means. In order to tack coating materials, accessories, such as clamps or the like, can be used.

The stated measures can also be used in combination, individually in each case. For example, a positive fit and adhesive bonding of the end portions can be applied.

The band-type or strip-type material can be a coating material provided with an activatable or reactivatable adhesive, wherein the adhesive can be transferred, using an activation means, into an adhesion-promoting state. In another embodiment, the band-type or strip-type material may be an adhesive strip which is applied to a workpiece or a coating material.

According to a further embodiment, the band-type or strip-type material is applied to a surface of a workpiece which is provided with an adhesive, in a coating device, or the band-type or strip-type material is provided with an adhesive, in a coating device.

The band-type or strip-type material may be a veneer strep or a strip-type/band-type material made of a synthetic material, for example PVC.

In order to achieve a connection of end portions of band-type or strip-type materials, an energy source may be provided, in particular a hot air source, laser source, infrared source, microwave source, or plasma source. The end portions of the band-type or strip-type materials, in particular adhesive portions provided in said portions, can be activated using an energy source of this kind, such that the adhesive can be used to establish a connection.

It is preferable for a detection means to furthermore be provided, in particular a light barrier or a camera, which is designed to detect end portions of band-type or strip-type materials. In this way, it is possible to ascertain that an end of a band-type or strip-type material is reached. Alternatively, or in addition, a position of one or more end portions can be detected, in order to ascertain an overlapping arrangement of the end portions. Thus, connection of the end portions in a defined region can be ensured.

It can furthermore be provided for an end portion of a band-type or strip-type material to be identified on the basis of a chip, for example an RFID chip, and/or a code, such as a barcode or a QR code, or a geometric shape, such as a notch, a recess, or the like. In this way, detection of an end portion can be ensured even more reliably.

It is preferable for the transport means to comprise a first drive mechanism and a second drive mechanism, wherein the joining means is arranged between the first and second drive mechanism, in the transport direction. Thus, successive materials can advantageously be arranged in an overlapping manner.

In this case, it is preferable for the drive mechanisms to be individually drivable. Thus, an exact positioning of end portions, to be connected, of two materials can be ensured.

It can furthermore be provided for a roller pair to be provided adjacently to the joining means in each case. Thus, end portions of successive materials can be supported adjacently to the joining means.

It is preferable for the storage means to comprise a receiving means for receiving a plurality of material units, wherein the storage means is designed to feed in the material units, along the receiving means. The receiving means can be designed as an arbor for example. The material units, in particular the cores thereof, can be received on the arbor.

According to one embodiment, a pressure device, in particular a spring, is provided, which is arranged such that the pressure device can feed in the material units, along the receiving means. In particular the material units can be fed in by the pressure device when a coating material or an adhesive strip of one of the material units is consumed.

According to another embodiment, the receiving means can be oriented in the vertical direction, such that the material units are pressed against a retainer, on account of gravity.

It can furthermore be provided for the storage means to be designed as a movable unit. As a result, the storage means can be exchanged and/or loaded with material units at another location.

According to a further embodiment, the feed system comprises a device for transferring an end portion of a band-type or strip-type material from a material unit received in the storage means to the transport means, wherein the device is designed to retain the end portion of the material and transfer it to the transport means. For example, the device for transferring an end portion can be designed as a robot having a robot arm, or a handing device.

Furthermore, a coating device for applying a band-type or strip-type material, in particular a strip-type or band-type coating material and/or an adhesive strip, to a workpiece, is provided. The coating device comprises a feed system, in particular a feed system according to any of the preceding aspects, and a pressure device, in particular a pressure roller, for pressing the band-type or strip-type material on the workpiece. The feed system comprises a joining means for connecting or joining end portions of band-type or strip-type materials, in particular coating materials or adhesive strips.

In one embodiment, the coating device can comprise control means which is designed to transmit control commands to drive mechanisms of the feed system. Thus, the drive mechanisms can be coordinated such that connection of end portions of b and-type or strip-type materials can be carried out in the shortest possible time.

In this case, it is preferable for the control means to control the drive mechanisms, in the event of a change of band-type or strip-type materials, such that the end portions of the materials are positioned in the joining means.

The invention furthermore relates to a method. Within the context of the method, the feed system and/or the coating device according to the above-mentioned aspects can be used.

During the step of connecting end portions of the band-type or strip-type materials, the end portions can be adhesively bonded, tacked, crimped, welded, and/or connected by means of a positive fit.

A positive fit can be made possible for example by a wedge-shaped or dovetail-like design or by a hook-like structure on the band-type or strip-type material. Thus, end portions of two band-type or strip-type materials can engage in one another, for example in the manner of mutually engaging puzzle pieces. A punching may also be provided on an end portion of the band-type or strip-type material, in which punching a complementary portion or a projection of an end portion of another band-type or strip-type material engages. Such an end portion of the band-type or strip-type material may be provided by the manufacturer, or otherwise made prior to or during use of the band-type or strip-type material.

Crimping can be achieved by corresponding action of force, for example by means of a pressure roller. In order to adhesively bond the end portions, the joining means may comprise an adhesive application means and/or an adhesive activation means. For the purpose of welding, the joining means may comprise a welding means. In order to tack coating materials, accessories, such as clamps or the like, can be used.

It can furthermore be provided to identify an end portion of a band-type or strip-type material on the basis of a chip, for example an RFID chip, and/or a code, such as a barcode or a QR code, or a geometric shape, such as a notch, a recess, or the like.

In one embodiment, it is provided that the connection region (of the end portions) is transferred to control means, such that the position of the connection region can be taken into account during a following coating process. In particular, the connection region can be removed during further transport, by means of a trimming apparatus.

Furthermore, a band-type or strip-type material, in particular a coating material or an adhesive strip, is provided, which comprises an end portion having a connection structure. This may for example be a wedge-shaped or dovetail-like design, an adhesive portion, a hook-like structure, and/or a punching on the band-type or strip-type material.

Thus, end portions of two band-type or strip-type materials can engage in one another. A punching may also be provided on an end portion of the band-type or strip-type material, in which punching a complementary portion or a projection of an end portion of another band-type or strip-type material engages or can engage. Such an end portion of the band-type or strip-type material may be provided by the manufacturer, or otherwise made prior to or during use of the band-type or strip-type material.

### BRIEF DESCRIPTION OF THE DRAWINGS

Further features and advantages of a system, a device, a use and/or a method can be found in the following description of embodiments, with reference to the accompanying drawings. In said drawings:

FIG. 1 is a schematic view of an embodiment of the invention.

FIG. 2 is a detailed view of the first embodiment shown in FIG. 1.

### DESCRIPTION OF THE EMBODIMENTS

The same reference numbers which are used in different figures denote identical, mutually corresponding, or functionally similar elements.

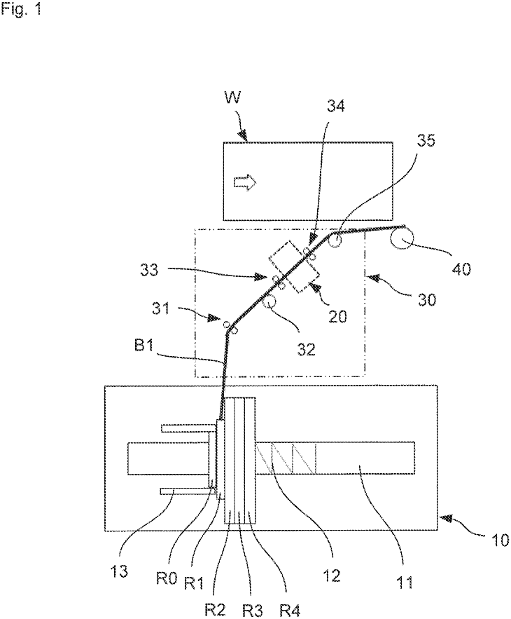

FIG. 1 is a schematic view of an embodiment, in order to describe the invention on the basis of an illustrative example.

The feed system comprises a storage means 10 and a transport means 30. The storage means 10 can be designed as a stationary storage means, or the storage means is arranged so as to be movable. In the case of a movable storage means, this is for example designed as a movable unit having rollers or the like.

According to the embodiment, the transport means 30 is part of a coating device (not shown), by means of which the coating material is applied to a narrow side of a platelike workpiece W. According to an amendment, however, the transport means 30 can also be provided independently of the coating device, and, if required, be arranged adjacently thereto or attached to the coating device.

The storage means 10 comprises a receiving means 11 on which a plurality of coating material units R0-R4 (preferably edge tape rolls) can be received, in particular slid on. Although, within the context of the embodiment, material units are described which receive a coating material, according to a further embodiment the material units can also provide adhesive strips.

Furthermore a spring (pressure device) 12 is provided, which is designed to push the coating material units R0-R4, received on the receiving means 11, in the direction of a retainer 13. In this case, the coating material units R0-R4 each comprise a strip-type or band-type coating material in roll form, which is in particular provided with an activatable or reactivatable adhesive.

Thus, a coating material B1 is removed from the coating material unit R1 arranged adjacently to the retainer 13, in that the coating material unit R1 is unwound. In this case, the removal of the coating material B1 is achieved by the transport means 30. In particular, the transport means 30 unwinds the coating material B1.

Further coating material units R2-R4 are provided on the side of the coating material unit R1 facing the spring 12, which also each contain a coating material. On the opposite side to the coating material unit R1, a coating material unit R0 is provided, the coating material of which has already been removed. In a manner similar to the remaining coating material units R1-R4, the coating material unit R0 is still received on the receiving means 11, but on occasion the coating material unit R0 can be taken off the receiving means 11.

The transport means 30 comprises a first roller pair 31, a second roller pair 33, and a third roller pair 34, wherein the first roller pair 31 is provided closest to the storage means 10, in the transport direction of the coating material B1, and thus serves for introducing the coating material. In this case, a transfer (or insertion) of the coating material B1 from the coating material unit R1 can take place manually or by means of a device, such as a robot.

A drive roller 32 (first drive mechanism) is provided between the first roller pair 31 and the second roller pair 33, by means of which drive roller the coating material is conveyed in the transport direction. A counter pressure roller (not shown) can optionally be provided opposite the drive roller 32, such that the coating material arrives through a conveying gap formed between the drive roller 32 and the counter pressure roller.

A joining means 20 is provided between the second roller pair 33 and the third roller pair 34, which joining means is designed to interconnect end portions of successive coating materials. In this case, an “end portion” means a portion at a start or an end of a coating material. The mode of operation and details of the joining means 20 are described in detail later.

A second drive roller 35 (second drive mechanism) is provided, arranged following the third roller pair 34 in the transport direction, which second drive roller is designed to feed the coating material to a pressure roller 40. A counter pressure roller (not shown) can optionally be provided opposite the second drive roller 35, such that the coating material arrives through a conveying gap formed between the second drive roller 35 and the counter pressure roller.

The pressure roller 40 is used for pressing the coating material onto a narrow side of the plate-shaped workpiece. In the embodiment, the pressure roller 40 is part of the coating device, but according to further embodiments it can also be part of the transport means 30.

The first drive roller 32 and the second drive roller 35 are each connected to control means. The drive rollers 32, 35 can be driven synchronously, or individually in each case, for example at different speeds, by the control means.

The synchronous drive of the drive rollers 32, 35 is suitable in particular for feeding in a coating material which is drawn off a coating material unit (for example coating material unit R1). If a roller change takes place, the drive rollers 32, 35 can thus be driven individually, wherein the second drive roller 35 can optionally be stopped. The joining means 20 comprises means by which end portions of coating materials can be interconnected, in order to thereby create an endless coating material. In this case, the joining means 20 can in particular be designed to adhesively bond, to tack, to crimp, to weld end portions of the coating materials, or to join respective geometries of the endportions of the coating materials to one another by means of a positive fit. The stated measures can also be implemented in combination with one another.

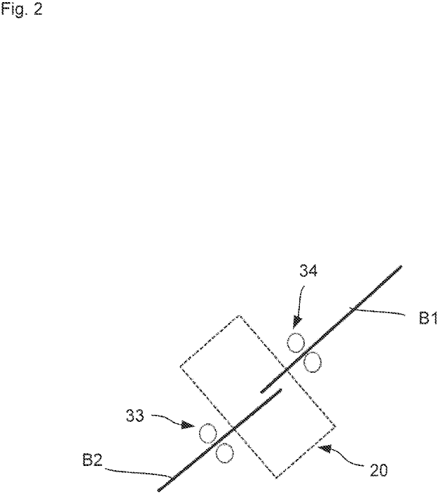

Connection of a coating material B1 to a following coating material B2 is shown schematically in FIG. 2. In particular, the end portions of the coating materials B1, B2 are arranged in an overlapping manner and subsequently interconnected. However, it is also possible to arrange the coating materials B1, B2, to be connected, edge-to-edge, and to interconnect them in this arrangement. In this case, the arrangement of the end portions of the coating materials B1, B2 is achieved by means of corresponding control commands of the control means to the drive rollers 32, 35.

A method is described in the following, by means of which coating materials can be interconnected.

In the storage means 10, a plurality of coating material units R0-R4 are received on the receiving means 11, wherein the coating material B1 is withdrawn from a first coating material unit R1.

If an end, in particular a roller end, of the coating material unit R1 is reached, then the end of the coating material B1 is conveyed further by the transport means 30. Since the spring 12 pushes the coating material units in the direction of the retainer 13, when an end of the coating material unit R1 is reached said first coating material unit R1 disengages from the retainer 13 and is guided, by means of the spring 12, along the receiving means 11 and into a similar position as the coating material unit R0 is guided. The coating material unit R0 is pushed further by the coating material unit R1. In the course of this, a second coating material unit R2 comes into contact with the retainer 13.

The coating material B2 provided on the second coating material unit R2 is transferred manually or by means of a device, such as a robot (not shown), to the first roller pair 31, and comes into engagement with the first drive roller 32.

The first drive roller 32 thus draws the second coating material B2 of the second coating material unit R2 and conveys the second coating material B2 into the region of the joining means 20. Said feeding of the coating material takes place such that the first coating material B1 (or an end portion thereof) is still arranged in the joining means 20, while the second coating material B2 is introduced into the joining means 20.

The joining means 20 can now carry out connection/joining of the first and second coating material B1, B2, in order to thereby create an endless coating material.

The joining means 20 is furthermore designed to detect the position of the connection region between the first and second coating material B1, B2, and to pass this information on to the coating device. Thereupon, the coating device adjusts the operation such that the connection region is not used as a coating material for a workpiece, but rather is detached by means of a tripping apparatus.

It is clear to a person skilled in the art that individual features, described in different embodiments in each case, can also be implemented in a single embodiment, provided that they are not structurally incompatible. Similarly, different features which are described within the context of a single embodiment can also be provided in a plurality of embodiments, individually or in any desired sub-combination.

Within the context of the embodiment, a pressure device 12 is described, which is designed to push the material units R0-R4, received on the receiving means 11, in the direction of a retainer 13. According to a further embodiment, the receiving means can also be oriented in the vertical direction, such that the material units are pressed against a retainer, on account of gravity.

1. A feed system for a band-type or strip-type material , the feed system comprising:
a storage means for receiving a plurality of material units; and
a transport means for moving a band-type or strip-type material from the storage means,
wherein the transport means comprises a joining means for connecting end portions of band-type or strip-type materials.

2. A feed system according to claim 1, wherein thejoining means is designed to couple end portions of band-type or strip-type materials together .

3. A feed system according to claim 1, wherein the joining means comprises as an energy source .

4. A feed system according to claim 1 claims, further comprising a detection means for detecting end portions of band-type or strip-type materials.

5. A feed system according to claim 1, wherein the transport means comprises a first drive mechanism and a second drive mechanism, and wherein the joining means is arranged between the first and second drive mechanism in the transport direction.

6. A feed system accordingto claim 5, wherein the drive mechanisms are individually drivable.

7. A feed system according to claim 5, wherein a roller pair is provided adjacently to the joining means.

8. A feed system according to claim 1, wherein the storage means comprises a receiving means for receiving a plurality of material units, wherein the storage means is designed to feed in the material units along the receiving means.

9. A feed system according to claim 8, wherein the storage means comprises a pressure device configured to feed in the material units along the receiving means.

10. A feed system according to claim 1, wherein the storage means is designed as a movable unit.

11. A feed system according to claim 1, further comprising a device for transferring an end portion of a band-type or strip-type material from a material unit received in the storage means to the transport means , wherein the device is designed to retain the end portion of the band-type or strip-type material and transfer it to the transport means.

12. A coating device for applying a coating material, in particular a strip-type or band-type coating material, to a workpiece, comprising a feed systemaccordingto claim 1, and a pressure device for pressing on the band-type or strip-type material .

13. A coating device according to claim 12, comprising control means configured to transmit control commands to drive mechanisms of the feed system for positioning, in the event of a change of band-type or strip-type materials, the end portions of the materials in the joining means.

14. A method, comprising the steps of:
moving a first band-type or strip-type material of a first material unit in a transport direction,
wherein, when an end of the first band-type or strip-type material is reached, a second band-type or strip-type material of a second material unit is moved in the transport direction, and
wherein the end portions of the band-type or strip-type materials are positioned such that the end portions of the materials can be connected.

15. A method according to claim 14, wherein the end portions of the band-type or strip-type materials are adhesively bonded, tacked, welded, crimped, or fitted together connected.

16. (canceled)

17. A feed system accordingto claim 1, wherein the joiningmeans glues, staples, presses, or welds the end portions.

18. A feed system according to claim 4, wherein the detection means comprises a light barrier or a camera.

19. A feed system according to claim 8, wherein the receiving means comprises a shaft aligned in a vertical direction so that the material units are pressed against a holder by gravity.

20. A feed system according to claim 9, wherein the pressure device comprises a spring.

21. A feed system accordingto claim 11, wherein the transport means comprises a robot or a handling means.
